(19) United States
(12) Patent Application Publication
(10) Pub. No.: US 2025/0358249 A1
(43) Pub. Date: Nov. 20, 2025

(54) METHOD FOR PROVIDING THREAD CHAT ROOM, NON-TRANSITORY COMPUTER-READABLE RECORDING MEDIUM, AND USER TERMINAL

(71) Applicant: LINE Plus Corporation, Seongham-si (KR)

(72) Inventors: Seo Hyun CHO, Seongham-si (KR); Daeun JUNG, Seongham-si (KR)

(73) Assignee: LINE Plus Corporation, Seongham-si (KR)

(21) Appl. No.: 19/078,384

(22) Filed: Mar. 13, 2025

(30) Foreign Application Priority Data
May 20, 2024 (KR) 10-2024-0065482

(51) Int. Cl. H04L 51/04; H04L 51/216

(52) U.S. Cl. CPC H04L 51/04; H04L 51/216

(57) ABSTRACT

A method for creating a thread chat room in an instant messaging application includes: receiving, from a user included in a chat room, a user input requesting creation of a thread chat room for a root message within the chat room, the thread chat room being separate from the chat room; creating the thread chat room based on receiving the user input; and displaying a list of thread chat rooms.

### CROSS-REFERENCE TO RELATED APPLICATION

This application claims priority to Korean Patent Application No. 10-2024-0065482, filed in the Korean Intellectual Property Office on May 20, 2024, the contents of which are incorporated by reference herein in its entirety.

### BACKGROUND

### 1. Field

This disclosure relates to a method for providing a thread chat room, a non-transitory computer-readable recording medium, and a user terminal. Specifically, one or more embodiments of the present disclosure relate to a method and system capable of creating a thread chat room on the basis of a user's request for creating the thread chat room in an instant messaging application and displaying a list of thread chat rooms.

### 2. Description of Related Art

The use of instant messaging applications on mobile devices, such as smartphones, is becoming widespread due to the proliferation of mobile devices and the advancement of the Internet. A user using an instant messaging application via a mobile device may exchange various messages and contents with other users through chat rooms.

Through the instant messaging application, a user may participate in a plurality of chat rooms and exchange messages with other users. In chat rooms where a plurality of users participate, conversations can take place simultaneously on various topics, and the topics of the conversations can change in real time. Users who want to obtain information on a specific topic may have a problem in that it is not easy to obtain information in such an environment and the conversation may not fluently flow. For this reason, it may take a long time to find the conversation content, in which the users are interested, in the chat room.

A large amount of conversations take place in real time in chat rooms within instant messaging applications. Even while the conversation on a specific topic is in progress, a new conversation on a new topic may be started by another user. In such a manner, as conversations on various topics are in progress sporadically within the chat room, it may not be easy to store and manage only conversations on the specific topic.

### SUMMARY

Provided are a method for providing a thread chat room within an instant messaging application, a non-transitory computer-readable recording medium, and a user terminal to solve the above-mentioned problems.

Additional aspects will be set forth in part in the description which follows and, in part, will be apparent from the description, or may be learned by practice of the presented embodiments.

The embodiments may be implemented in various ways, which include a method, a device (system), or a computer program stored on a readable storage medium.

According to an aspect of the disclosure, a method for creating a thread chat room in an instant messaging application may include: receiving, from a user included in a chat room, a user input requesting creation of a thread chat room for a root message within the chat room, the thread chat room being separate from the chat room; creating the thread chat room based on receiving the user input; and displaying a list of thread chat rooms.

The method may further include: providing the thread chat room to a plurality of users included in the chat room, where the thread chat room provides information about the root message within the chat room and a user that sent the root message within the chat room.

The list of thread chat rooms may be provided separately from a list of chat rooms including the chat room.

The list of thread chat rooms may include a favorite thread list including a list of thread chat rooms archived by the user.

The list of thread chat rooms may include: a favorite thread list including a list of thread chat rooms archived by the user, and an entire thread list including a list of all thread chat rooms viewable to the user, where the displaying of the list of thread chat rooms includes: selectably presenting the favorite thread list or the entire thread list.

The method may further include: displaying the thread chat room, where the thread chat room provides a first interface to archive the thread chat room in the favorite thread list; and receiving a second user input via the first interface to archive the thread chat room in the favorite thread list.

The method may further include archiving the thread chat room in the favorite thread list of the user based on receiving the second user input.

The method may further include displaying the chat room, where the chat room provides a second interface configured to enable access to the list of thread chat rooms.

The selectably presenting the favorite thread list or the entire thread list may include displaying the entire thread list in a state in which the favorite thread list is empty.

The selectably presenting the favorite thread list or the entire thread list may include displaying the favorite thread list in a state in which the favorite thread list includes one or more thread chat rooms archived by the user.

The method may further include displaying the chat room including information about the thread chat room in the chat room, wherein the information about the thread chat room includes at least one of information about a number of messages in the thread chat room, or information about a number of messages unread by the user among the messages in the thread chat room.

The method may further include displaying a list of chat rooms, where the list of chat rooms provides a third interface configured to enable access to the list of thread chat rooms.

The method may further include displaying the thread chat room, where the thread chat room provides a fourth interface configured to enable access to the root message within the chat room.

The displaying the list of thread chat rooms may include displaying a list of thread chat rooms in order from a thread chat room having a most recent message.

The method may further include: disabling the thread chat room based on a threshold time having passed from a first time point at which the root message within the chat room is received.

The method may further include: receiving a deletion request for the root message within the chat room; and deleting the thread chat room from the list of thread chat rooms based on receiving the deletion request.

The method may further include: disabling the thread chat room based on a threshold time having passed from a second time point at which the user input requesting the creation of the thread chat room is received.

The creating the thread chat room may include: in a state in which a threshold time has passed from a first time point at which the root message within the chat room is received, displaying a request rejection screen based on receiving the user input.

According to an aspect of the disclosure, a non-transitory computer-readable recording medium storing instructions for execution by the one or more processors that, when executed by the one or more processors, cause the one or more processors to perform a method, where the method may include: receiving, from a user included in a chat room, a user input requesting creation of a thread chat room for a root message within the chat room, the thread chat room being separate from the chat room; creating the thread chat room based on receiving the user input; and displaying a list of thread chat rooms.

According to an aspect of the disclosure, a user terminal may include: a display; a memory storing at least one computer-readable program; and at least one processor operatively connected to the memory and configured to execute the at least one computer-readable program to: receive, from a user included in a chat room, a user input requesting creation of a thread chat room for a root message within the chat room, the thread chat room being separate from the chat room, create the thread chat room based on receiving the user input, and display a list of thread chat rooms.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates an example of creating a thread chat room in an instant messaging application according to some embodiments of the present disclosure;

FIG. 2 schematically illustrates a configuration in which an information processing system is connected to a plurality of user terminals to communicate therewith in order to provide a thread chat room provision service in the instant messaging application according to some embodiments of the present disclosure;

FIG. 3 illustrates a block diagram showing an internal configuration of the user terminal and the information processing system according to some embodiments of the present disclosure;

FIG. 4 illustrates an example of a thread chat room in the instant messaging application according to some embodiments of the present disclosure;

FIG. 5 illustrates an example of entering lists of thread chat rooms according to some embodiments of the present disclosure;

FIG. 6 illustrates an example of shifting to a list of thread chat rooms created in association with a chat room through a list of chat rooms according to some embodiments of the present disclosure;

FIG. 7 illustrates an example of shifting to a list of all thread chat rooms added to favorites through the list of chat rooms according to some embodiments of the present disclosure; and

FIG. 8 illustrates a flowchart showing an example of a method 800 for providing a thread chat room in the instant messaging application according to some embodiments of the present disclosure.

### DETAILED DESCRIPTION

Hereinafter, examples for carrying out embodiments of the present disclosure will be described in detail with reference to the accompanying drawings. However, in the following description, in a case where there is a concern that the gist of the present disclosure may be undesirably made unclear, descriptions of well-known functions or configurations will not be repeated.

In the accompanying drawings, identical or corresponding components are represented by the same reference numerals and signs. Note that, in the following description of the embodiments, redundant descriptions of identical or corresponding components may not be repeated. However, even in a case where a component is not described, it is not intended that some embodiments do not include such a component.

The advantages and features of the disclosed embodiments, and the methods for achieving the advantages and features will be clarified with reference to the embodiments to be described later together with the accompanying drawings. However, the present disclosure is not limited to the embodiments disclosed below, but may be modified into various different forms. The embodiments are only provided to make the present disclosure complete and to fully inform a general person skilled in the art of the scope of the disclosure.

The terms used in the present specification will be briefly explained, and the exemplary embodiments will be described. The terms used in the present specification are selected as general terms widely used at present as possible while considering the functions in the embodiments of the present disclosure. However, the terms may be changed depending on intention of a person skilled in the art of the relevant field, precedents, the emergence of new technologies, and the like. Note that, in certain cases, the applicants may arbitrarily select some terms. In such a case, the meanings thereof will be described in detail in the corresponding descriptions of the embodiments. Therefore, the terms used in the embodiments of the present disclosure are not simply the names of the terms, but should be defined on the basis of the meanings of the terms and the overall description of the present disclosure.

Expressions in the singular in the present specification may include the plural unless the context clearly indicates that the expressions are singular. Note that, the plural expressions include expressions in the singular unless the context clearly indicates that the expressions are plural. It will be understood that the terms “includes,” “comprises,” “has,” “having,” “including,” “comprising,” and the like when used in this specification, specify the presence of stated features, figures, steps, operations, components, members, or combinations thereof, but do not preclude the presence or addition of one or more other features, figures, steps, operations, components, members, or combinations thereof. As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

Note that, the term ‘module’ or ‘section’ used in the specification means a software or hardware component, and the ‘module’ or ‘section’ may perform certain functions. However, the ‘module’ or ‘section’ is not limited to software or hardware. The ‘module’ or ‘section’ may be configured to be on an addressable storage medium and may be configured to be implemented by one or more processors. Accordingly, examples of the ‘module’ or ‘section’ may include at least one of components such as software components, object-oriented software components, class components, and task components, and processes, functions, attributes, procedures, subroutines, segments of program code, drivers, firmware, microcode, circuitry, data, databases, data structures, tables, arrays, or variables. The components and ‘modules’ or ‘sections’ may be combined into a smaller number of components and ‘modules’ or ‘sections’, or may be further divided into additional components and ‘modules’ or ‘sections’.

According to some embodiments of the present disclosure, the ‘module’ or ‘section’ may be implemented by a processor and a memory. The ‘processor’ should be broadly defined to include one or more of a general purpose processor, a central processing unit (CPU), a microprocessor, a digital signal processor (DSP), a controller, a microcontroller, a state machine, or the like. In some circumstances, the ‘processor’ may also refer to one or more of an application specific integrated circuit (ASIC), a programmable logic device (PLD), a field programmable gate array (FPGA), or the like. The ‘processor’ may also refer to, for example, a combination of processing devices, such as a combination of a DSP and a microprocessor, a combination of a plurality of microprocessors, a combination of one or more microprocessors in conjunction with a DSP core, or a combination of any other such components. Note that, the ‘memory’ should be broadly defined to include any electronic component capable of storing electronic information. The ‘memory’ may also refer to various types of processor-readable media, such as any one or more of a random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, and registers. The memory is expressed to be in electronic communication with the processor in a case where the processor is able to perform at least one of reading information from or writing information to the memory. The memory integrated into the processor is in electronic communication with the processor.

In the embodiments of the present disclosure, the ‘system’ may include at least one of a server device or a cloud device, but is not limited thereto. For example, the system may be configured with one or more server devices. In an embodiment, the system may be configured with one or more cloud devices. In an embodiment, the system may be configured with and operated by both a server device and a cloud device.

In the embodiments of the present disclosure, the ‘display’ may refer to any display device associated with a computing device. For example, the ‘display’ may refer to any display device that is controlled by the computing device or capable of displaying any information and data provided by the computing device.

In the embodiments of the present disclosure, ‘each of a plurality of As’ or ‘a plurality of As each’ may refer to each of all components included in the plurality of As, or may refer to each of some components included in the plurality of As.

In the embodiments of the present disclosure, the ‘user’ may refer to a user using an instant messaging application or a user account of an instant messaging application. Here, a user account may refer to an account created and used by a user in an instant messaging application or data associated therewith.

In the embodiments of the present disclosure, the ‘chat room’ may refer to a virtual space or group which may be created in an instant messaging application installed on a computing device and in which one or more users (or user accounts) may participate. For example, one or more user accounts may participate (e.g., be included) in a chat room and exchange various forms of messages, files, and the like with one another. Note that, the chat room may support a Voice over Internet Protocol (VoIP) call function or a VolP group call function. Thus, at least one of a voice call or a video call may be performed between user accounts.

In the embodiments of the present disclosure, an “instant messaging application” may refer to any software or application platform that supports real-time or near real-time communication between users. For example, the “instant messaging application” may include IMessage, WhatsApp, Snapchat, Telegram, or the like, but is not limited thereto. In the embodiments of the present disclosure, the service provided by the “instant messaging application” may be referred to as an “instant messaging service.”

In the embodiments of the present disclosure, the ‘thread chat room’ may refer to a virtual space or group which may be created on the basis of messages in a chat room created in an instant messaging application and in which one or more users (or user accounts) may be included. For example, a user (or user account) participating in a chat room may create a thread chat room in order to freely discuss a common topic or ask questions and share answers on the basis of specific messages in the chat room. In some embodiments, in the thread chat room, one or more user accounts may be included in the thread chat room and exchange various forms of messages, files, and the like with one another, just like the chat room.

In the embodiments of the present disclosure, the ‘list of thread chat rooms’ may be a list of thread chat rooms created in an instant messaging application. The list of thread chat rooms may refer to a list of all thread chat rooms in which a user (or a user account) is included, regardless of whether or not the thread chat rooms are created in association with a specific chat room. In some embodiments, the list of thread chat rooms may refer to a list of thread chat rooms created in association with a specific chat room in which a user (or a user account) is included.

Hereinafter, various embodiments of the present disclosure will be described in detail with reference to the accompanying drawings. The sizes or positions of display screens, images, buttons, and the like illustrated and described in the drawings are merely examples and are not limited thereto. For example, some buttons may be added or omitted, or the sizes and positions thereof may be configured to be different from the illustrated sizes and positions.

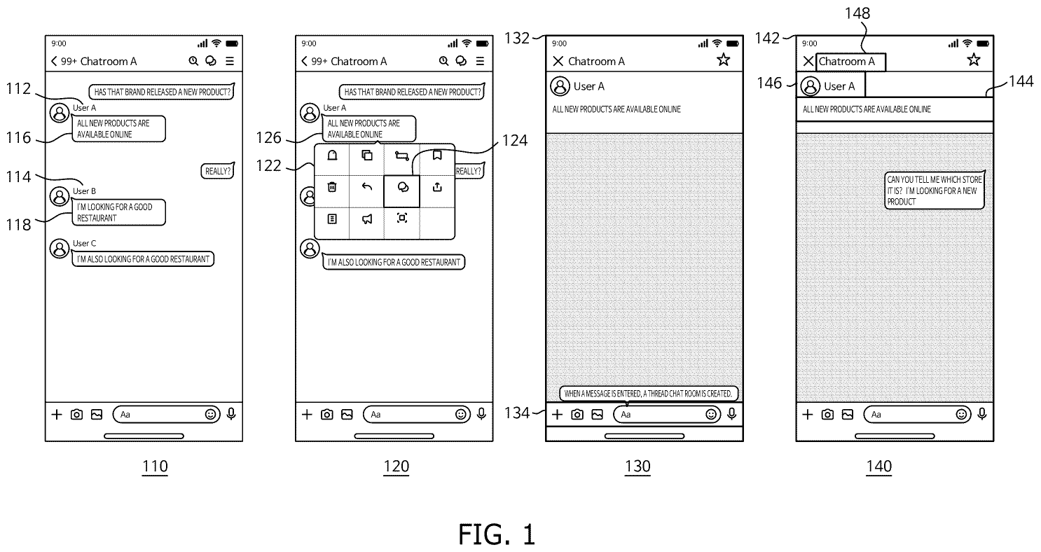

FIG. 1 illustrates an example of creating a thread chat room in an instant messaging application according to some embodiments of the present disclosure. As illustrated in the drawing, a thread chat room can be created through a process illustrated in first to fourth screens 110 to 140.

The first screen 110 shows an example of a scene where users have conversations in a chat room. Various conversation topics may be established among users who are included in the chat room. For example, a user A 112 may present a conversation topic “New products are available online” 116, and at the same time, a user B 114 may present a conversation topic “I'm looking for a good restaurant” 118.

In some embodiments, users participating in the chat room may be able to exchange messages in various forms. Examples of the messages that users are able to exchange may include text messages, voice messages, picture messages, video messages, and the like, but the messages are not limited thereto.

The second screen 120 shows an example of receiving a user input requesting creation of a thread chat room from a user participating in the chat room. Users participating in the chat room may request creation of a thread chat room by selecting one of the various messages listed in the chat room in order to have a conversation only about a specific topic.

In some embodiments, the user may be provided with an interface 122 for executing an additional function for a specific message. In such a case, the interface 122 for executing the additional function may be displayed to the user in a case where the user touches a specific message for a certain period of time. However, conditions for displaying the interface 122 are not limited thereto. In some embodiments, the interface 122 for executing the additional function may be displayed to the user in a case where the user double-clicks or right-clicks the specific message.

Thereafter, the user may be provided with a button 124 for creating a thread chat room in the interface 122 for executing the additional function for the specific message. When the user clicks the button 124 for creating the thread chat room, a screen 132 for creating the thread chat room may be displayed to the user. Here, the message within the chat room that is the basis for creating the thread chat room may be referred to as a root message 126.

In some embodiments, the user who wants to create the thread chat room may input a message responding to the root message 126 in a message input window 134. For example, in response to the root message 126 saying “All new products are available online” in the chat room, the user who wants to create the thread chat room may input a message saying “Can you tell me which store it is? I'm looking for a new product too”. In such a manner, the user who wants to create a thread chat room may create the thread chat room by inputting a message responding to the root message 126 in the message input window 134 provided in the screen 132 for creating the thread chat room.

The fourth screen 140 shows an example of a screen where creation of the thread chat room is completed. As illustrated in the drawing, a thread chat room 142 may be separate from the chat room.

In some embodiments, the thread chat room 142 may be provided with a content 144 of the root message within the chat room and information 146 about the user who sends the root message within the chat room. For example, in a case where the thread chat room is created on the basis of the root message 126 sent by the user A 112, the thread chat room may be provided with the profile information 146 of the user A 112 and the content 144 of the root message. In some embodiments, only the profile information 146 of the user A 112 may be provided in the thread chat room, and only the content 144 of the root message that is the basis for creating the thread chat room may be provided. The information provided to the thread chat room is not limited thereto and may include other contents. With such a configuration, users in the thread chat room are able to easily know which user sends the root message and are able to easily grasp the topic of conversation within the thread chat room.

In some embodiments, information 148 of a chat room that is the basis for creating a thread chat room may be provided to the thread chat room. For example, in a case where the thread chat room is created on the basis of a root message 126 sent in a chat room A, the title information 148 of the chat room A may be provided to the thread chat room. With such a configuration, the users in the thread chat room are able to easily identify which chat room the thread chat room is created on the basis of.

In some embodiments, in a case where the user requests creation of a thread chat room on the basis of a root message that remains after a certain period of time has passed since the root message was sent, a request rejection screen may be displayed in response to a user input requesting the creation of the thread chat room. For example, when 24-hours have passed since the root message was sent in the chat room, the request rejection screen may be displayed in response to the user input requesting the creation of the thread chat room on the basis of the root message. The request rejection screen responding to the user input may be displayed on the user display in the form of a pop-up window in response to the user clicking the button 124 for creating a thread chat room on the second screen 120. With such a configuration, the thread chat rooms can be prevented from indiscriminately being created and the thread chat room in which information on the latest topics is exchanged can be created.

In some embodiments, when a certain period of time has passed since the root message was sent in the chat room, the thread chat room created on the basis of the root message may be disabled. For example, when six months have passed since the root message was sent in the chat room, the thread chat room created on the basis of the root message may be disabled. In such a case, in the disabled thread chat room, messages already entered can be viewed without being deleted, but new messages may not be sent.

In some embodiments, in a case where the root message is deleted from the chat room, the thread chat room created on the basis of the root message may be deleted.

In some embodiments, when a certain period of time has passed since the thread chat room was created, the thread chat room may be disabled. For example, when one month has passed since the thread chat room was created, the thread chat room may be disabled. In such a case, in the disabled thread chat room, messages already entered can be viewed without being deleted, but new messages may not be sent. With such a configuration, in the thread chat room, conversations can be directed to specific topics, and thread chat rooms that remain after a certain period of time has passed can be disabled, thereby increasing an efficiency of a server that manages the thread chat room.

With such a configuration, the user can be provided with a conversation space where the user is able to have a conversation or obtain information only about a specific topic among various conversations exchanging in the chat room. In some embodiments, by providing a separate thread chat room for conversations about specific topics, the conversation about the specific topic can be prevented from being interrupted. As a result, the user is able to easily obtain desired information in the chat room and manage the chat room in units of topic.

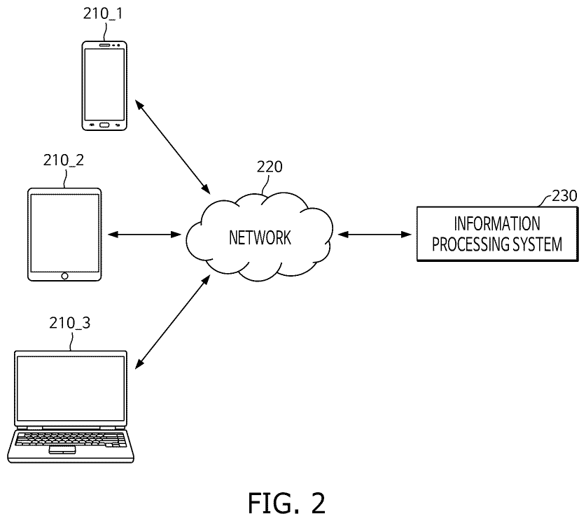

FIG. 2 schematically illustrates the following configuration. An information processing system 230 may be connected to a plurality of user terminals 210_1, 210_2, and 210_3 and be able to communicate therewith to provide a thread chat room provision service according to some embodiments of the present disclosure. The information processing system 230 may include at least one of a system (or systems) capable of providing an instant messaging service and a system (or systems) capable of providing a thread chat room provision service. In some embodiments, the information processing system 230 may include: at least one of a server device or a database capable of storing, providing, and executing computer-executable programs (for example, downloadable applications) and data relating to at least one of the instant messaging service or the thread chat room provision service; or at least one of a distributed computing device or a distributed database based on a cloud computing service. For example, the information processing system 230 may include separate systems (for example, servers) for at least one of the instant messaging service or the thread chat room provision service.

The instant messaging service, the thread chat room provision service, and the like provided by the information processing system 230 may be provided to the user through an instant messaging application, and the like installed on each of the plurality of user terminals 210_1, 210_2, and 210_3. For example, the instant messaging service may include a text messaging service, a voice messaging service, a video call service, a voice call service, a video streaming service, a social network service, a thread chat room provision service, and the like, between users of the instant messaging application.

The plurality of user terminals 210_1, 210_2, and 210_3 may communicate with the information processing system 230 via a network 220. The network 220 may be configured to be capable of communication between the information processing system 230 and the plurality of user terminals 210_1, 210_2, and 210_3. Depending on the installation environment, the network 220 may be configured as, for example, a wired network such as Ethernet, a wired home network (Power Line Communication), a telephone line communication device, and RS-serial communication, a wireless network such as a mobile communication network, wireless LAN (WLAN), Wi-Fi, Bluetooth, and ZigBee, or a combination thereof. The communication method is not limited thereto. The communication method may include a communication method utilizing a communication network (such as a mobile communication network, a wired Internet, a wireless Internet, a broadcasting network, or a satellite network) that may be included in the network 220. The communication method may include a short-range wireless communication among the user terminals 210_1, 210_2, and 210_3.

In FIG. 2, a mobile phone terminal 210_1, a tablet terminal 210_2, and a PC terminal 210_3 are illustrated as examples of the user terminals. However, the user terminals 210_1, 210_2, and 210_3 are not limited thereto, and may be any computing device capable of at least one of wired communication or wireless communication and capable of installing and executing an instant messaging application, and the like. For example, the user terminal may include a smartphone, a mobile phone, a navigation device, a computer, a laptop, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. FIG. 2 illustrates that three user terminals 210_1, 210_2, and 210_3 communicate with the information processing system 230 via the network 220. However, the present disclosure is not limited thereto, and a different number of user terminals may be configured to communicate with the information processing system 230 via the network 220.

In some embodiments, each of the user terminals 210_1, 210_2, and 210_3 may receive information or data from or send information to other user terminals via the network 220.

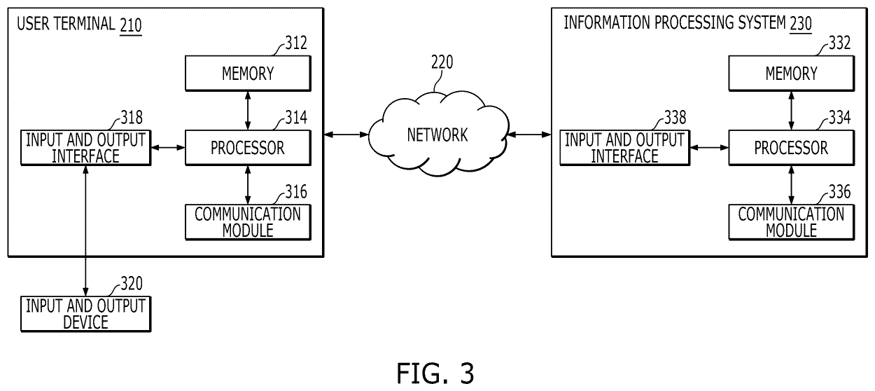

FIG. 3 illustrates a block diagram showing an internal configuration of the user terminal 210 and the information processing system 230 according to some embodiments of the present disclosure. The user terminal 210 may refer to any computing device capable of executing an application, a web browser, and the like and capable of at least one of wired communication or wireless communication. For example, the user terminal 210 may include the mobile phone terminal 210_1, the tablet terminal 210_2, or PC terminal 210_3 shown in FIG. 2. As illustrated in the drawing, the user terminal 210 may include a memory 312, a processor 314, a communication module 316, and an input-output interface 318. Similarly, the information processing system 230 may include a memory 332, a processor 334, a communication module 336, and an input-output interface 338. As illustrated in FIG. 3, the user terminal 210 and the information processing system 230 may be configured to perform communication of at least one of information or data via the network 220 using the respective communication modules 316 and 336. In some embodiments, the input-output device 320 may be configured to input at least one of information or data to the user terminal 210 or output at least one of information or data created from the user terminal 210 via the input-output interface 318.

The memories 312 and 332 each may include any non-transitory computer-readable recording medium. According to some embodiments, the memories 312 and 332 each may include a permanent mass storage device such as a read only memory (ROM), a disk drive, a solid state drive (SSD), or a flash memory. In some embodiments, the user terminal 210 or the information processing system 230, as a separate permanent storage device distinct from the memory, may include a permanent mass storage device such as a ROM, an SSD, a flash memory, or a disk drive. In other embodiments, the memories 312 and 332 each may store an operating system and at least one program code.

The software components may be loaded from a computer-readable recording medium separate from the memories 312 and 332. The separate computer-readable recording medium may include a recording medium directly connectable to the user terminal 210 and the information processing system 230. For example, the recording medium may include computer-readable recording media such as a floppy drive, a disk, a tape, a DVD/CD-ROM drive, and a memory card. In some embodiments, software components may be loaded into the memories 312 and 332 via the communication modules 316 and 336 that are not computer-readable recording media. For example, at least one program may be loaded into the memories 312 and 332 on the basis of a computer program that is installed by files provided by developers or a file distribution system distributing installation files of applications via the network 220.

The processors 314 and 334 each may be configured to process commands of a computer program by performing basic arithmetic, logic, and input-output operations. The commands may be provided to the processors 314 and 334 by the memories 312 and 332 or the communication modules 316 and 336. For example, the processors 314 and 334 may be configured to execute the commands received in accordance with the program codes stored in the recording devices such as the memories 312 and 332.

The communication modules 316 and 336 may provide a configuration or function for the user terminal 210 and the information processing system 230 to communicate with each other via the network 220. The communication modules 316 and 336 may provide a configuration or function for at least one of the user terminal 210 or the information processing system 230 to communicate with another user terminal or another system (such as a separate cloud system). For example, a request or data (such as a chat room search request), which is created by the processor 314 of the user terminal 210 in accordance with a program code stored in a recording device such as the memory 312, may be sent to the information processing system 230 through the network 220 under control of the communication module 316. Conversely, the user terminal 210 may receive a control signal or a command, which is provided under the control of the processor 334 of the information processing system 230, through the communication module 316 of the user terminal 210 via the communication module 336 and the network 220. The communication modules 316 and 336 may be also referred to as communication interfaces, and may be implemented by any one or any combination of a digital modem, a radio frequency (RF) modem, an antenna circuit, a WiFi chip, and related software and/or firmware.

The input-output interface 318 may be a section for interfacing with the input-output device 320. Examples of the input device may include devices, such as a camera, a keyboard, a microphone, and a mouse, each including at least one of an audio sensor or an image sensor. Examples of the output device may include devices such as a display, a speaker, and a haptic feedback device. In some embodiments, the input-output interface 318 may be a section, such as a touch screen, for interfacing with a device having an integrated configuration or function for performing input and output. For example, in a case where the processor 314 of the user terminal 210 processes a command of a computer program loaded into the memory 312, the display may display a service screen and the like, which are configured using at least one of information or data provided by the information processing system 230 or another user terminal, through the input-output interface 318. FIG. 3 may indicate that the user terminal 210 does not include the input-output device 320. However, the input-output device 320 is not limited thereto, and may be configured to be integrated with the user terminal 210 as being a single device. In some embodiments, the input-output interface 338 of the information processing system 230 may be a section for interfacing with a device for input or output that is connected to the information processing system 230 or that the information processing system 230 may include. FIG. 3 illustrates that the input-output interfaces 318 and 338 are elements configured separately from the processors 314 and 334. However, the input-output interfaces 318 and 338 are not limited thereto, and may be configured to be included in the processors 314 and 334.

The user terminal 210 and the information processing system 230 may include more components than the components in FIG. 3. However, it is not necessary to clearly illustrate most of the components in the related art. In some embodiments, the user terminal 210 may be implemented to include at least some of the input-output devices 320 described above. In some embodiments, the user terminal 210 may further include components such as a transceiver, a global positioning system (GPS) module, a camera, various sensors, a database, and the like. For example, in a case where the user terminal 210 is a smartphone, the user terminal 210 may include components that are generally included in a smartphone. For example, the user terminal 210 may be implemented to further include various components such as an acceleration sensor, a gyro sensor, a microphone module, a camera module, various physical buttons, buttons using a touch panel, input-output ports, and a vibrator for vibration.

While a program for the instant messaging application including the thread chat room provision service is running, the processor 314 may receive at least one of a text, an image, a video, a voice, a motion, or the like, which is input or selected through an input device such as a camera or microphone including at least one of a touch screen, a keyboard, an audio sensor, or an image sensor connected to the input-output interface 318. In such a case, the processor 314 may store the received at least one of the text, image, video, voice, motion, or the like in the memory 312 or may provide the information processing system 230 therewith through the communication module 316 and the network 220.

The processor 314 of the user terminal 210 may be configured to perform at least one of management, processing, or storing on at least one of information or data received from at least one of the input-output device 320, another user terminal, the information processing system 230 or a plurality of external systems. At least one of the information or the data processed by the processor 314 may be provided to the information processing system 230 via the communication module 316 and the network 220. The processor 314 of the user terminal 210 may send at least one of the information or the data to the input-output device 320 via the input-output interface 318 and may output at least one of the information or the data. For example, the processor 314 may display the received at least one of information or data on the screen of the user terminal 210.

The processor 334 of the information processing system 230 may be configured to perform at least one of management, processing, or storing of at least one of the information or the data received from at least one of the plurality of user terminals 210 or a plurality of external systems. At least one of the information or the data processed by the processor 334 may be provided to the user terminal 210 via the communication module 336 and the network 220.

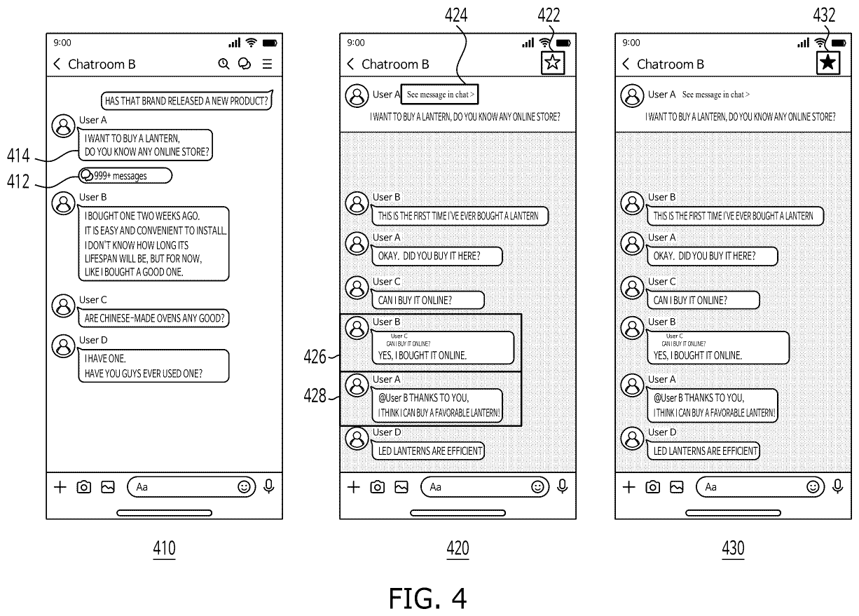

FIG. 4 illustrates an example of a thread chat room in the instant messaging application according to some embodiments of the present disclosure.

A first screen 410 shows an example of a chat room to which a root message that is the basis for creating a thread chat room is sent. A second screen 420 shows an example of the thread chat room created on the basis of the root message. A third screen 430 shows an example of a thread chat room that is added to a list of favorite thread chat rooms.

In some embodiments, a button 412 for entering a thread chat room associated with a root message 414 may be provided in the chat room. In the first screen 410, the button 412 for entering the thread chat room associated with the root message 414 may be provided around the root message 414 in the chat room. For example, a user may enter a thread chat room created on the basis of the message 414 saying “I want to buy a lantern, do you know any online store?” by clicking the button 412 saying “999+ messages” provided at the lower end of the message 414 saying “I want to buy a lantern, do you know any online store?”.

In some embodiments, the button 412 for entering the thread chat room may include information relating to the thread chat room. Here, the information relating to the thread chat room may be information about the number of messages in the thread chat room or information about the number of messages that are not yet read by the user in the thread chat room. For example, in a case where the number of messages in the thread chat room is 5, a button for entering the thread chat room may be displayed as “5 messages”. In some embodiments, in a case where the number of messages in the thread chat room is equal to or greater than 10 and less than 50, equal to or greater than 50 and less than 100, and equal to or greater than 100 and less than 1000, the button for entering the thread chat room may be displayed as, for example, “10+ messages”, “50+ messages”, and “100+ messages” or “200+ messages”, respectively. In some embodiments, in a case where the number of messages in the thread chat room is equal to or greater than 1000, the button for entering the thread chat room may be displayed as “999+ messages”. In some embodiments, in a case where the number of messages yet unread by the user in the thread chat room is 5, the button for entering the thread chat room may be displayed as “5 messages”. In some embodiments, in a case where the number of messages yet unread by the user in the thread chat room is equal to or greater than 10 and less than 50, equal to or greater than 50 and less than 100, or equal to or greater than 100 and less than 1000, the button for entering the thread chat room may be displayed as, for example, “10+ messages”, “50+ messages”, and “100+ messages” or “200+ messages”, respectively. In some embodiments, in a case where the number of messages yet unread by the user in the thread chat room is equal to or greater than 1000, the button for entering the thread chat room may be displayed as “999+ messages”. The method for displaying information relating to the thread chat room described above is merely an example and is not limited thereto.

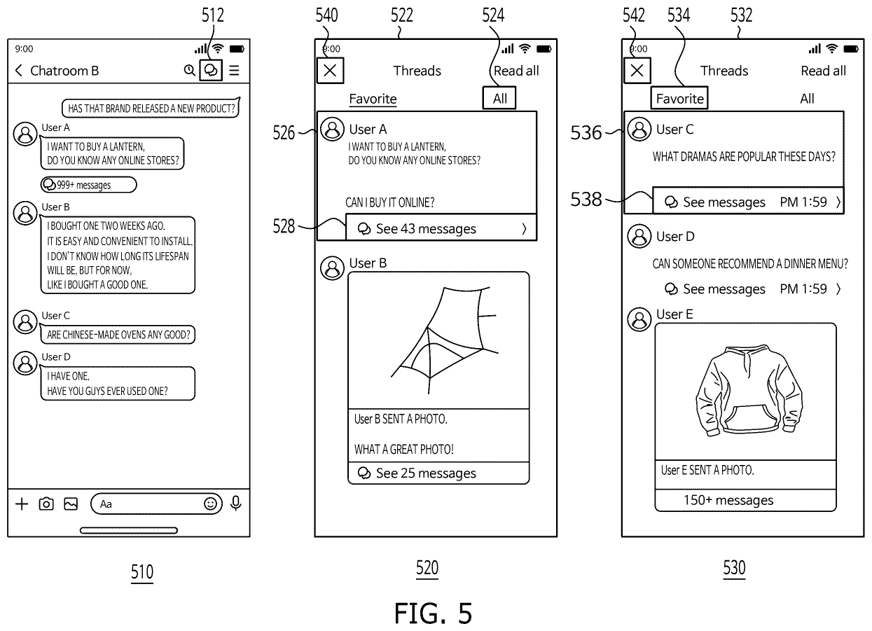

In some embodiments, the thread chat room may be provided with the interface 422 that allows the user to add the thread chat room to a favorite thread list. The favorite thread list may be a list of thread chat rooms designated as favorites by the user. As used herein, the “favorite thread list” may refer to a collection, archive, or other mechanism by which specific thread chatrooms designated by the user are provided for reference or later access. Thus, thread chat rooms “designated as favorites” may refer to the thread chat rooms that are stored, pinned, archived, or otherwise collected in the favorite thread list. The thread chat room added to the favorite thread list may be individually managed through the favorite thread list, as described later in FIG. 5, and may be easily accessed by the user.

The thread chat room may be added to the favorite thread list by selecting the interface 422 that allows the user to add the thread chat room provided in the thread chat room to the favorite thread list through a touch input or the like. The display may display confirmation information indicating a state where the thread chat room is added to the favorite thread list. For example, in a case where the user selects the interface 422 having an outlined star shape, the interface 422 may be changed to an interface 432 having a solid star shape, and may be displayed on the display. In such a case, the thread chat room may be added to the favorite thread list. Conversely, even in a case where the thread chat room is already added to the favorite thread list, the thread chat room may be deleted from the favorite thread list by selecting the interface 432 provided in the thread chat room through a touch input or the like. The display may display confirmation information that the thread chat room is not added to the favorite thread list through the interface 422 that allows the user to add the thread chat room to the favorite thread list. For example, in a case where the interface 432 having a solid star shape is selected by a user, the interface 432 may be changed to the interface 422 having an outlined star shape, and may be displayed on the display. With such a configuration, the user may be able to easily determine whether the corresponding thread chat room is added to the favorite thread list, and is able to efficiently manage the favorite thread list.

In some embodiments, an interface 424 linked to the root message 414 that is the basis for creating the corresponding thread chat room may be provided in the thread chat room. By selecting the interface 424 linked to the root message 414 through a touch input or the like, the display may display the chat room screen at the time point where the root message 414 is sent. For example, in a case where the thread chat room is created on the basis of the root message 414 saying “I want to buy a lantern, do you know any online store?”, the interface 424 saying “See message in chat” provided in the thread chat room may be selected through a touch input or the like. Therefore, the display may display a chat room screen with the root message 414 saying “I want to buy a lantern, do you know any online store?” placed at the top. With such a configuration, screen shift between the chat room and the thread chat room can be efficiently performed.

In some embodiments, functions that can be performed in chat rooms may be performed in a similar manner in the thread chat room. For example, text messaging, photo taking, picture messaging, voice messaging, file sending, and the like may be performed in the thread chat room. In some embodiments, a user in the thread chat room may mention 428 another user or may send a reply 426 to a specific message. The functions that may be performed in the thread chat room mentioned above are merely examples and are not limited thereto.

In some embodiments, in a case where the user participating in the thread chat room is mentioned 428 by a different user participating in the thread chat room, the thread chat room to which the mention message is sent may be automatically added to the favorite thread list of the user mentioned by the different user. For example, in a case where the user A mentions the user B with a message saying “@User B Thanks to you, I think I can buy a favorable lantern!”, the thread chat room to which the mention message is sent may be automatically added to the favorite thread list of the user B. With such a configuration, the user is able to efficiently manage the thread chat rooms in which the user is mentioned.

In some embodiments, in a case where the reply to the message sent by the specific user participating in the thread chat room is sent 426 by another user participating in the thread chat room, the thread chat room to which the reply is sent may be automatically added to the favorite thread list of the specific user. For example, in a case where the user B sends a replay saying “Yes, I bought it online” in response to a message saying “Can I buy it online?” sent by the user C, the thread chat room to which the reply is sent may be automatically added to the favorite thread list of the user C. With such a configuration, the user is able to efficiently manage thread chat rooms in which replies are sent to the user.

In some embodiments, the favorite thread list of the user who requests the creation of the thread chat room may add the thread chat room created at the user's request. For example, in a case where the user B requests the creation of the thread chat room on the basis of the root message 414 saying “I want to buy a lantern, do you know any online stores?”, the thread chat room created at the user B's request may be added to favorite thread list of the user B. With such a configuration, the user may be able to efficiently manage the thread chat room created at the user's request.

FIG. 5 illustrates an example of entering lists of thread chat rooms according to some embodiments of the present disclosure.

A first screen 510 shows an example of an interface 512 that is linked to a list of thread chat rooms in a chat room. A second screen 520 shows an example of a favorite thread list 522. A third screen 530 shows an example of an entire thread list 532. Here, the list of the thread chat rooms linked through the chat room may be a list of thread chat rooms created in association with a specific chat room. In some embodiments, the favorite thread list may be a list of thread chat rooms designated as favorites by a user, and the entire thread list may be a list of all threads from all chat rooms that a user is able to view.

In some embodiments, the chat room may be provided with the interface 512 that is linked to lists of thread chat rooms. When a user belonging to the chat room selects the interface 512 that is linked to the lists of thread chat rooms through a touch input or the like, the display may display the lists of thread chat rooms 522 and 532. With such a configuration, instead of searching for the root message that is the basis for creating a thread chat room by scrolling or the like and then entering the thread chat room, the user is able to easily view the lists of thread chat rooms. As a result, it may be possible to improve accessibility to the thread chat rooms and possible to facilitate management of the thread chat rooms.

In some embodiments, the lists of thread chat rooms linked through the interface 512 provided in the chat room may be the lists of thread chat rooms created in association with the chat room. For example, the lists of thread chat rooms created in the chat room A may be linked through the interface provided in the chat room A, and may not be linked through the interface provided in chat room B.

In some embodiments, the lists of thread chat rooms may be provided separately from the list of chat rooms. In some embodiments, the lists of thread chat rooms may include the favorite thread list 522 and the entire thread list 532. Here, the favorite thread list 522 and the entire thread list 532 may be presented to be selectable by the user. The favorite thread list 522 may list thread chat rooms which are created in association with the chat room and designated as favorites by the user. The entire thread list 532 may list all the thread chat rooms created in association with the chat room. In such a case, thread chat rooms belonging to the favorite thread list 522 and the entire thread list 532 may overlap at least partially. Providing the favorite thread list 522 may enable efficient management of thread chat rooms on specific topics of interest to the user. In addition, providing the entire thread list 532 may improve accessibility to thread chat rooms created within the chat room, and may increase participation in the thread chat room and activity of the thread chat room.

In some embodiments, the favorite thread list 522 may be provided with an interface 524 linked to the entire thread list 532. Similarly, the entire thread list 532 may be provided with an interface 534 linked to the favorite thread list 522. The user may be able to enter the desired list of thread chat rooms by selecting the interface through a touch input or the like.

In some embodiments, information 526 and information 536 about thread chat rooms may be displayed in the favorite thread list and the entire thread list. Here, the information 526 and the information 536 about the thread chat rooms may include profile information about the user who sends the root message, the content of the root message, information about the number of messages in the thread chat room, the content of the last message sent in the thread chat room, information about the sending time, information about the number of messages unread by the user in the thread chat room, and the like. The information 526 and the information 536 about thread chat rooms are not limited to the above-mentioned configurations. A different configuration other than the above-mentioned configurations may be added, or some of the above-mentioned configurations may be removed. With such a configuration, the user may be able to easily understand the information about thread chat rooms listed in the lists of thread chat rooms, and may be able to efficiently identify the thread chat room that the user is looking for.

In the favorite thread list 522, information about each of a plurality of thread chat rooms may be provided. For example, in the favorite thread list 522, information about each of a thread chat room for a root message of the user A and a thread chat room for a root message of the user B may be displayed. Similarly, information about each of the plurality of thread chat rooms may be provided in the entire thread list 532. For example, in the entire thread list 532, information about each of a thread chat room for a root message of a user C, a thread chat room for a root message of a user D, and a thread chat room for a root message of a user E may be displayed.

In some embodiments, the favorite thread list and the entire thread list may provide interfaces 528 and 538 that are linked to thread chat rooms. The user may enter a desired thread chat room by selecting the interfaces 528 and 538 that are linked to thread chat rooms through a touch input or the like. In some embodiments, the interfaces 528 and 538 linked to the thread chat rooms may include information relating to the thread chat rooms. Here, the information relating to the thread chat room may be information about the number of messages in the thread chat room or information about the number of messages that are not yet read by the user in the thread chat room. For example, in a case where the number of messages in the thread chat room is 5, the interface that is linked to the thread chat room may be displayed as “5 messages”. In some embodiments, in a case where the number of messages in the thread chat room is equal to or greater than 10 and less than 50, equal to or greater than 50 and less than 100, and equal to or greater than 100 and less than 1000, the interface that is linked to the thread chat room may be displayed as, for example, “10+ messages”, “50+ messages”, and “100+ messages” or “200+ messages”, respectively. In some embodiments, in a case where the number of messages in the thread chat room is equal to or greater than 1000, the interface that is linked to the thread chat room may be displayed as “999+ messages”. In some embodiments, in a case where the number of messages yet unread by the user in the thread chat room is 5, the button for entering the thread chat room may be displayed as “5 messages”. In some embodiments, in a case where the number of messages yet unread by the user in the thread chat room is equal to or greater than 10 and less than 50, the interface that is linked to the thread chat room may be displayed as “10+ messages”. In some embodiments, in a case where the number of messages yet unread by the user in the thread chat room is equal to or greater than 50 and less than 100, the interface that is linked to the thread chat room may be displayed as “50+ messages”. In some embodiments, in a case where the number of messages yet unread by the user in the thread chat room is equal to or greater than 100 and less than 1000, the interface that is linked to the thread chat room may be displayed as “100+ messages” or “200+ messages”, depending on the number of unread messages. In some embodiments, in a case where the number of messages yet unread by the user in the thread chat room is equal to or greater than 1000, the interface that is linked to the thread chat room may be displayed as “999+ messages”. The method for displaying information relating to the thread chat room described above is merely an example and is not limited thereto.

In some embodiments, the favorite thread list and the entire thread list may provide interfaces 540 and 542 for returning to the chat room. The user may return to the chat room before entering the lists of thread chat rooms by selecting the interfaces 540 and 542 for returning to the chat room through a touch input or the like. With such a configuration, it may be possible to perform smooth shift between the chat room and the lists of thread chat rooms, and may be possible to efficiently manage the thread chat room and access to the thread chat room.

In some embodiments, in a case where the chat room is linked to the lists of thread chat rooms, if the favorite thread list 522 is empty, the entire thread list 532 may be preferentially displayed. In some embodiments, in a case where the favorite thread list includes one or more thread chat rooms designated as favorites by the user 522, the favorite thread list 522 may be preferentially displayed.

In some embodiments, the thread chat rooms in the lists of thread chat rooms may be sequentially listed in order of the most recent message sent in the thread chat room. In a case where the message is sent in the thread chat room, the thread chat room may be placed at the top. As the thread chat room is placed at the top, the remaining thread chat rooms may be placed one step lower. In some embodiments, the thread chat rooms in the lists of thread chat rooms may be sorted in an order of popularity or recommendation determined by an artificial intelligence-based learning model electrically connected to the processors 314 and 334, and may be displayed on the input-output interface 318.

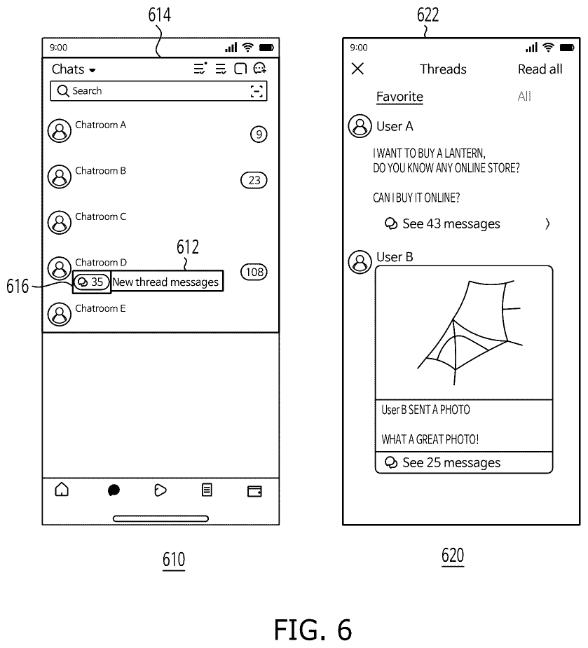

FIG. 6 illustrates an example of shifting to a list of thread chat rooms created in association with a chat room through a list of chat rooms according to some embodiments of the present disclosure.

A first screen 610 shows an example of a list of chat rooms including an interface 612 that links from a list of chat rooms 614 to a list of thread chat rooms 622. A second screen 620 shows an example of the list of thread chat rooms 622 that are linked from the list of chat rooms 614. The list of thread chat rooms 622 that are linked from the list of chat rooms 614 may be a list of thread chat rooms created in association with a specific chat room.

In some embodiments, the list of chat rooms 614 may list chat rooms in which a user is participating. In some embodiments, the list of chat rooms 614 may provide the interface 612 that links from the list of thread chat rooms 622 that are created in association with each chat room. For example, the user may select the interface 612 saying “New thread messages” placed at the lower end of a chat room title through a touch input or the like, thereby being linked to the list of thread chat rooms 622 created in association with the chat room. In such a case, the list of thread chat rooms 622 linked from the list of chat rooms 614 may be the favorite thread list or the list of all chat rooms. Accordingly, although the favorite thread list is shown on the second screen 620, the link to the entire thread list through the list of chat rooms may not be excluded. With such a configuration, the user may enter the list of thread chat rooms 622 created in association with the chat room without going through several steps in the list of chat rooms 614. As a result, the user may efficiently manage the list of thread chat rooms, and accessibility to the thread chat rooms may be increased.

In some embodiments, the display may display information 616 relating to the thread chat room created in association with the chat room in the list of chat rooms 614. Here, the information 616 associated with the thread chat room may include information about the number of messages unread by the user among messages included in the thread chat room. In some embodiments, the information 616 associated with the thread chat room may be at least one of the content of the root message, the time the root message is sent, or information about the user who sends the root message. In some embodiments, the information 616 associated with the thread chat room may include information about the number of threads in the chat room or information about the number of threads in the chat room that include the messages unread by the user.

In some embodiments, in the list of thread chat rooms 622, the thread chat rooms may be listed sequentially from the most recent message sent in the thread chat room. In a case where the message is sent in the thread chat room, the thread chat room may be placed at the top. As the thread chat room is placed at the top, the remaining thread chat rooms may be placed one step lower. In some embodiments, the thread chat rooms in the lists of thread chat rooms 622 may be sorted in an order of popularity or recommendation determined by an artificial intelligence-based learning model electrically connected to the processors 314 and 334, and may be displayed on the input-output interface 318.

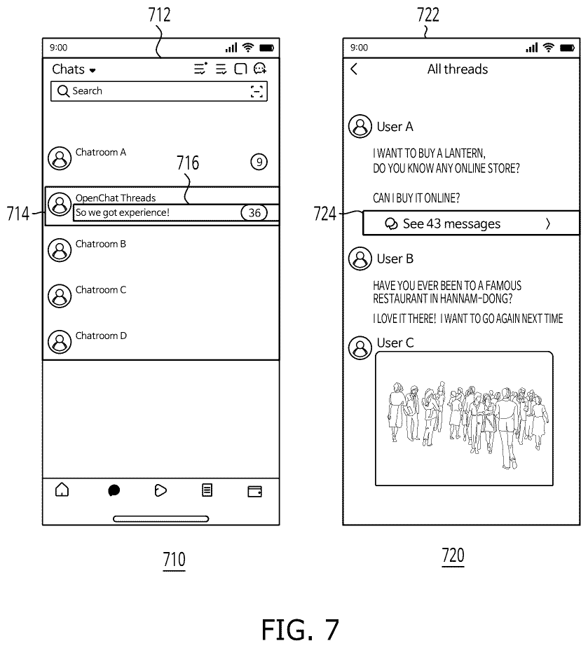

FIG. 7 illustrates an example of shifting to a list of all thread chat rooms added to favorites through a list of chat rooms according to some embodiments of the present disclosure.

A first screen 710 illustrates an example of a list of chat rooms 712 that provides an interface 714 that is linked to a list of all thread chat rooms added to favorites 722 from the list of chat rooms 712. A second screen 720 illustrates an example of the list of all thread chat rooms added to favorites 722 that are linked from the list of chat rooms 712.

In some embodiments, the list of chat rooms 712 may list chat rooms in which a user is participating. In some embodiments, the interface 714 may be provided that is linked to the list of all thread chat rooms added to favorites 722 in the list of chat rooms 712. The user may select the interface 714 saying “OpenChat Threads” provided in the list of chat rooms 712 through a touch input or the like, thereby being linked to the list of all thread chat rooms added to favorites 722. In such a case, the list of all thread chat rooms added to favorites 722 linked from the list of chat rooms 712 may list all thread chat rooms that are designated as favorites by the user in the instant messaging application, regardless of whether or not the thread chat rooms are associated with a specific chat room. For example, the list of all thread chat rooms added to favorites 722 may list all thread chat rooms created on the basis of the chat room A that is designated as a favorite by the user and all thread chat rooms created on the basis of the chat room B that is designated as a favorite by the user.

In some embodiments, an interface may be provided that is linked to a list of all thread chat rooms in which the user is participating in the list of chat rooms 712. The user may select the interface that is linked to a list of all thread chat rooms provided in the list of chat rooms 712 through a touch input or the like, thereby being linked to a list of all thread chat rooms in which the user is participating. In such a case, the list of all thread chat rooms linked from the list of chat rooms 712 may list all thread chat rooms in which the user is participating in the instant messaging application, regardless of whether or not the thread chat rooms are associated with a specific chat room.

In some embodiments, the interface 714 may include information 716 associated with the thread chat room. Here, the information 716 associated with the thread chat room may be information about the number of messages unread by the user among the messages included in the thread chat room. In some embodiments, the information 716 associated with the thread chat room may be the content of the most recently sent message in the thread chat room. In some embodiments, the information 716 associated with the thread chat room may include information about the number of threads or information about the number of the threads including the messages unread by the user among threads in the chat room in which the user is participating.

In some embodiments, as described above, the list of all thread chat rooms added to favorites 722 may provide an interface 724 that is linked to the thread chat room.

With such a configuration, the user may enter the list of all thread chat rooms added to favorites 722 without going through several steps in the list of chat rooms 712. As a result, the user may efficiently manage the lists of thread chat rooms, and accessibility to the thread chat rooms may be increased.

In some embodiments, in the list of all thread chat rooms added to favorites 722, the thread chat rooms may be listed sequentially from the most recent message sent in the thread chat rooms. In a case where the message is sent in the thread chat room, the thread chat room may be placed at the top. As the thread chat room is placed at the top, the remaining thread chat rooms may be placed one step lower. In some embodiments, the thread chat rooms in the lists of thread chat rooms 622 may be sorted in an order of popularity or recommendation determined by an artificial intelligence-based learning model electrically connected to the processors 314 and 334, and may be displayed on the input-output interface 318.

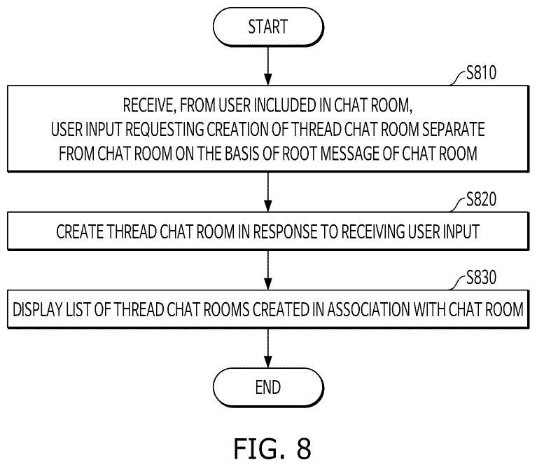

FIG. 8 illustrates a flowchart showing an example of a method 800 for providing a thread chat room in the instant messaging application according to some embodiments of the present disclosure. In some embodiments, the method 800 may be performed by at least one processor (at least one processor of a user terminal or an information processing system). The method 800 may include receiving, by the processor, a user input requesting creation of a thread chat room separate from a chat room on the basis of a root message of the chat room from a user included in the chat room (S810). Then, the processor may create the thread chat room in response to receiving the user input (S820). Thereafter, the processor may display a list of thread chat rooms (S830).

In some embodiments, the list of thread chat rooms may be provided separately from the list of chat rooms including the chat rooms.

In some embodiments, the list of thread chat rooms may include a favorite thread list, which is a list of thread chat rooms that are designated as favorites by the user. In some embodiments, the list of thread chat rooms may include a list of all thread chat rooms that the user is able to view. In such a case, the processor may selectively present the favorite thread list and the entire thread list.

In some embodiments, the processor may receive an additional request to add the thread chat room to the favorite thread list. In such a case, the thread chat room may provide a first interface through which the thread chat room can be added to the favorite thread list.

In some embodiments, the processor may add the thread chat room to the user's favorite thread list in response to receiving the user input requesting the creation of the thread chat room.

In some embodiments, the chat room may provide a second interface that is linked to the list of thread chat rooms. In such a case, the processor may preferentially display the entire thread list in a case where the favorite thread list is empty. In some embodiments, the processor may preferentially display the favorite thread list in a case where one or more thread chat rooms designated as favorites by the user are present in the favorite thread list.

In some embodiments, the processor may display information about the thread chat room in the chat room. In such a case, the information about the thread chat room may include at least one of information about the number of messages in the thread chat room or information about the number of messages unread by the user among messages included in the thread chat room.

In some embodiments, the processor may provide the thread chat room to a plurality of users in the chat room including the users. In such a case, the thread chat room may provide information about the root message within the chat room and the user who sends the root message within the chat room.

In some embodiments, the processor may display the list of chat rooms. In such a case, the list of chat rooms may provide a third interface that is linked to the lists of thread chat rooms.

In some embodiments, the thread chat room may provide a fourth interface that is linked to the root message within the chat room.

In some embodiments, the processor may sequentially display the thread chat rooms in order of the most recently sent messages within the thread chat room.

In some embodiments, the processor may determine whether or not a threshold time has passed from a first time point at which the root message within the chat room is received. Further, if the processor determines that the threshold time has passed from the first time point at which the root message within the chat room is received, the processor may disable the thread chat room.

In some embodiments, the processor may receive a delete request for the root message within the chat room. The processor may delete the thread chat room from the list of thread chat rooms on the basis of the received delete request.

In some embodiments, the processor may determine whether or not the threshold time has passed from a second time point at which the user input requesting the creation of the thread chat room is received. The processor may disable the thread chat room if the processor determines that the threshold time has passed since the second time point at which the user input requesting the creation of the thread chat room is received.

In some embodiments, the processor may determine whether or not the threshold time has passed from a third time point at which the root message within the chat room is received. If the processor determines that the threshold time has passed from the third time point at which the root message within the chat room is received, the processor may display a screen for rejecting a request for user input in response to receiving the user input requesting the creation of the thread chat room.

The flowchart illustrated in FIG. 8 and the description described above are merely examples, and may be implemented in different ways in other embodiments. For example, an order of some steps may be changed, some steps may be omitted, other configurations may be added, and some steps described as being sequentially performed may be simultaneously performed.

The method described above may be provided as a computer program that is stored on a computer-readable recording medium in order to be executed by a computer. The medium may continuously store a computer-executable program, or may temporarily store the program to execute or download the program. In some embodiments, the medium may be a various recording sections or storage sections each having the form in which a single or multiple hardware sections are combined. The medium is not limited to a medium directly connected to a computer system, and may be distributed on a network. Examples of the medium may include magnetic media such as hard disks, floppy disks, and magnetic tapes, optical recording medium such as CD-ROMs and DVDs, magneto-optical media such as floptical disks, and ROMs, RAMs, flash memories, and the like, and may be configured to store program commands. In some embodiments, examples of other media may include recording media and storage media managed by app stores that distribute applications and sites, servers, and the like that supply or distribute other various software.

The methods, operations, or techniques of the present disclosure may be implemented by various sections. For example, such techniques may be implemented by hardware, firmware, software, or a combination thereof. A general person skilled in the art will understand that the various exemplary logical blocks, modules, circuits, and algorithm steps described in connection with the present disclosure may be implemented as electronic hardware, computer software, or combinations of both. To clearly describe such interchangeability of hardware and software, the various exemplary components, blocks, modules, circuits, and steps are described above generally in terms of their functionality. Whether such functionality is implemented as hardware or software depends on the particular application and design requirements imposed on the entire system. A general person skilled in the art may implement the described functionality in various ways for each particular application, but it should not be understood that such implementations depart from the scope of the present disclosure.

In the hardware implementation, the processing units used to perform the techniques may be implemented by one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, a computer, or a combination thereof.

Accordingly, the various exemplary logical blocks, modules, and circuits described in connection with the present disclosure may be implemented or performed by a general-purpose processor, a DSP, an ASIC, an FPGA or other programmable logic device, discrete gate or transistor logic, discrete hardware components, or any combination of elements designed to perform the functions described herein. A general-purpose processor may be a microprocessor, but in the other embodiments, the processor may be any processor, controller, microcontroller, or state machine in the related art. The processor may also be implemented as a combination of computing devices, for example, a combination of a DSP, a microprocessor, a plurality of microprocessors, one or more microprocessors in conjunction with a DSP core, or any other configurations.

In implementation of at least one of firmware or software, the techniques may be implemented as commands stored on a computer-readable medium, such as a random access memory (RAM), a read-only memory (ROM), a non-volatile random access memory (NVRAM), a programmable read-only memory (PROM), an erasable programmable read-only memory (EPROM), an electrically erasable PROM (EEPROM), flash memory, a compact disc (CD), a magnetic or optical data storage device, or the like. The commands may be executable by one or more processors and may cause the processor (processors) to perform certain aspects of the functionality described in the present disclosure.

In implementation using software, the techniques may be stored as one or more commands or codes on a computer-readable medium, or may be sent through a computer-readable medium. The computer-readable media includes any medium that facilitates sending of a computer program from one place to another, and includes both computer storage media and communication media. The storage media may be any available media that can be accessed by a computer. Examples of such computer-readable media, which are not limited, may include RAM, ROM, EEPROM, CD-ROM or other optical disk storage, magnetic disk storage or other magnetic storage devices, or any other medium that can be used to send or store desired program code in the form of commands or data structures and that can be accessed by a computer. In other embodiments, any other medium may be appropriately referred to as a computer-readable medium.

For example, the software may be sent from a website, server, or other remote source through coaxial cable, fiber optic cable, twisted pair, digital subscriber line (DSL), or wireless technologies such as infrared, radio, and microwave. In such a case, the definition of media may include the coaxial cable, fiber optic cable, twisted pair, digital subscriber line, or wireless technologies such as infrared, radio, and microwave. The disks and discs described herein may include CDs, laser discs, optical discs, digital versatile discs (DVDs), floppy disks, and Blu-ray discs. Here, the disks typically are used to reproduce data magnetically, while the discs are typically used to reproduce data optically using lasers. Combinations of the above-mentioned elements may also be included within the scope of computer-readable media.

A software module may reside in RAM memory, flash memory, ROM memory, EPROM memory, EEPROM memory, registers, a hard disk, a removable disk, a CD-ROM, or any other form of the well-known storage medium. An exemplary storage medium may be connected to the processor such that the processor is able to read information from or write information to the storage medium. In other embodiments, the storage medium may be integrated into the processor. The processor and the storage medium may be provided in the ASIC. The ASIC may be provided in a user terminal. In other embodiments, the processor and the storage medium may be provided as separate components in the user terminal.

Although the embodiments described above have been described as utilizing aspects of the presently disclosed subject matter on one or more stand-alone computer systems, the present disclosure is not limited thereto. The present disclosure may be embodied in connection with any computing environment, such as a network or distributed computing environment. Aspects of the present disclosure may be embodied in a plurality of processing chips or devices, and the storage may have a similar effect over a plurality of devices. Such devices may include PCs, network servers, and portable devices.

According to some embodiments of the present disclosure, users in the thread chat room may be able to easily know which root message the thread chat room is created based on, and can easily know a topic of conversation in the thread chat room.

According to some embodiments of the present disclosure, the thread chat rooms may be prevented from indiscriminately being created, and the thread chat room in which information on the latest topic is exchanged can be created.

According to some embodiments of the present disclosure, in the thread chat room, conversations can be directed to specific topics, and thread chat rooms that remain after a certain period of time has passed can be disabled, thereby increasing an efficiency of a server that manages the thread chat room.

According to some embodiments of the present disclosure, a user may be able to have a conversation or obtain information only about a specific topic among various conversations exchanging in the chat room. In some embodiments, by providing the separate thread chat room for the specific topic, the conversation about the specific topic can be prevented from being interrupted. Accordingly, a user may be able to easily obtain desired information within the chat room and manage conversations in units of the specific topic.

According to some embodiments of the present disclosure, a user may be able to easily determine whether the thread chat room is added to the list of favorite thread chat rooms and may be able to easily manage the list of favorite thread chat rooms.

According to some embodiments of the present disclosure, shift between the chat rooms and the thread chat rooms may be efficiently performed.

According to some embodiments of the present disclosure, it may be possible to efficiently manage the thread chat room associated with a specific user.

According to some embodiments of the present disclosure, a user may be able to easily view the list of thread chat rooms without having to find the root message that is the basis for creating the thread chat room within the chat room through scrolling or the like. As a result, may be possible to improve accessibility to the thread chat rooms and may be possible to facilitate management of the thread chat rooms.

According to some embodiments of the present disclosure, by providing the list of favorite thread chat rooms, it may be possible to efficiently manage the thread chat rooms on the specific topics of interest to the user. Also, by providing the list of all thread chat rooms, it may be possible to improve accessibility to the thread chat rooms created within the chat room, and may be possible to increase participation in thread chat rooms and activity of thread chat rooms.

The advantages of the embodiments of the present disclosure are not limited to the advantages mentioned above. A person who has general knowledge in the technical field according to the embodiments of the present disclosure (referred to as a “general person skilled in the art”) may clearly understand other advantages not mentioned above from the description of the claims.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A method for creating a thread chat room in an instant messaging application, performed by at least one processor, the method comprising:
receiving, from a user included in a chat room, a user input requesting creation of a thread chat room for a root message within the chat room, the thread chat room being separate from the chat room;
creating the thread chat room based on receiving the user input; and
displaying a list of thread chat rooms.

2. The method as claimed in claim 1, further comprising:
providing the thread chat room to a plurality of users included in the chat room,
wherein the thread chat room provides information about the root message within the chat room and a user that sent the root message within the chat room.

3. The method as claimed in claim 1, wherein the list of thread chat rooms is provided separately from a list of chat rooms including the chat room.

4. The method as claimed in claim 1, wherein the list of thread chat rooms includes a favorite thread list including a list of thread chat rooms archived by the user.

5. The method as claimed in claim 1, wherein the list of thread chat rooms includes:
a favorite thread list including a list of thread chat rooms archived by the user, and
an entire thread list including a list of all thread chat rooms viewable to the user, and
wherein the displaying of the list of thread chat rooms comprises:
selectably presenting the favorite thread list or the entire thread list.

6. The method as claimed in claim 4, further comprising:
displaying the thread chat room, wherein the thread chat room provides a first interface configured to archive the thread chat room in the favorite thread list; and
receiving a second user input via the first interface to archive the thread chat room in the favorite thread list.

7. The method as claimed in claim 6, further comprising archiving the thread chat room in the favorite thread list of the user based on receiving the second user input.

8. The method as claimed in claim 1, further comprising displaying the chat room, wherein the chat room provides a second interface configured to enable access to the list of thread chat rooms.

9. The method as claimed in claim 5, wherein the selectably presenting the favorite thread list or the entire thread list comprises displaying the entire thread list in a state in which the favorite thread list is empty.

10. The method as claimed in claim 5, wherein the selectably presenting the favorite thread list or the entire thread list comprises displaying the favorite thread list in a state in which the favorite thread list includes one or more thread chat rooms archived by the user.

11. The method as claimed in claim 1, further comprising displaying the chat room including information about the thread chat room in the chat room,
wherein the information about the thread chat room includes at least one of information about a number of messages in the thread chat room, or information about a number of messages unread by the user among the messages in the thread chat room.

12. The method as claimed in claim 1, further comprising displaying a list of chat rooms,
wherein the list of chat rooms provides a third interface configured to enable access to the list of thread chat rooms.

13. The method as claimed in claim 1, further comprising displaying the thread chat room,
wherein the thread chat room provides a fourth interface configured to enable access to the root message within the chat room.

14. The method as claimed in claim 1, wherein the displaying the list of thread chat rooms comprises displaying a list of thread chat rooms in order from a thread chat room having a most recent message.

15. The method as claimed in claim 1, further comprising:
disabling the thread chat room based on a threshold time having passed from a first time point at which the root message within the chat room is received.

16. The method as claimed in claim 1, further comprising:
receiving a deletion request for the root message within the chat room; and
deleting the thread chat room from the list of thread chat rooms based on receiving the deletion request.

17. The method as claimed in claim 1, further comprising:
disabling the thread chat room based on a threshold time having passed from a second time point at which the user input requesting the creation of the thread chat room is received.

18. The method as claimed in claim 1, wherein the creating the thread chat room comprises:
in a state in which a threshold time has passed from a first time point at which the root message within the chat room is received, displaying a request rejection screen based on receiving the user input.

19. A non-transitory computer-readable recording medium storing instructions that, when executed by one or more processors, cause the one or more processors to perform the method according to claim 1.

20. A user terminal comprising:
a display;
a memory storing at least one computer-readable program; and
at least one processor operatively connected to the memory and configured to execute the at least one computer-readable program to:
receive, from a user included in a chat room, a user input requesting creation of a thread chat room for a root message within the chat room, the thread chat room being separate from the chat room,
create the thread chat room based on receiving the user input, and
display a list of thread chat rooms.
